(19) United States
(12) Patent Application Publication
(10) Pub. No.: US 2010/0277891 A1
(43) Pub. Date: Nov. 4, 2010

(54) LED CASING STRUCTURE

(75) Inventors: CHIEN-YUAN CHEN, TAIPEI CITY (TW); YI-SHENG CHEN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: POWER DATA COMMUNICATIONS CO., LTD., TAIPEI COUNTY (TW)

(21) Appl. No.: 12/710,591

(22) Filed: Feb. 23, 2010

(30) Foreign Application Priority Data
Apr. 29, 2009 (TW) 098207197

(51) Int. Cl. F21V 9/16

(52) U.S. Cl. 362/84

(57) ABSTRACT

A light emitting diode LED casing structure, particularly to an LED casing structure having two or more layers, includes a phosphor distributed uniformly between plastic film layers in an LED casing, such that the phosphor in the LED casing will not be drifted and sunk easily during the manufacturing process of an LED.

### BACKGROUND OF THE INVENTION

1. Field of the Invention

The present invention relates to a light emitting diode LED casing structure, and more particularly relates to an LED casing with a multilayer structure and a technical measure of preventing phosphor packaged in the LED casing from being drifted or sunk during the manufacturing process.

2. Description of the Related Art

With reference to FIGS. 6 and 7 for a conventional LED structure, the conventional LED structure comprises: a base 90, including a support frame, positive and negative electrode plates with a specific gap formed between the positive and negative electrode plates, and a support leg disposed at the bottom of the base 90; a chip installed on the positive and negative electrode plates, and soldered with gold wires; and a casing 70 packaged by an epoxy resin, wherein the conventional casing 70 is doped and filled with a phosphor 80 during its manufacture, wherein the phosphor 80 is impacted by lights emitted from the chip to produce different colors depending on the chemical composition of the phosphor 80.

To achieve uniform colors and improve the luminous flux of the LED, each LED of the same color series and the same color temperature is related closely to the casing 70. Only if the phosphor 80 is uniformly distributed in the casing 70, the manufactured LED will be able to enhance the LED performance and achieve a uniform quality. However, this view is not with the facts, and the conventional phosphor 80 is put into the epoxy resin of the manufacturing casing 70 first before the casing 70 is molded, such that when the epoxy resin doped and filled with the phosphor 80 is used for packaging the top of the base 90 and formed into the casing 70, the weight of phosphor 80 or the kinetic energy produced when the base 90 is being covered by the casing 70 during a gradual condensation process of the epoxy resin will cause the phosphor 80 to sink towards the bottom, and the phosphor 80 contained in the casing 70 of each LED will fall down gradually to constitute a non-uniform distribution or even a scattered distribution of the phosphor 80. As a result, the luminous flux of the LED will be reduced, and each LED of the same color series will have different color temperatures and poor color saturations, and these drawbacks are major causes to the bottleneck of the packaging technology.

### SUMMARY OF THE INVENTION

In view of the shortcomings of the prior art, the inventor of the present invention based on years of experience in the related industry to conduct extensive researches and experiments, and finally developed an LED casing structure in accordance with the present invention.

Therefore, it is a primary objective of the present invention to overcome the aforementioned shortcomings and deficiencies of the prior art by providing an LED casing structure in accordance with the present invention.

To achieve the foregoing objective, the present invention applies a first plastic film layer first before the LED casing is formed, and a phosphor is distributed on a flat surface of the first plastic film layer, and another film is coated to press and fix the phosphor in order to maintain the uniformly distributed feature, and then the two film layers are stamped into the form of the casing structure, so that the phosphor is sandwiched by the two film layers of the casing to maintain the position of the phosphor and prevent it from being drifted or deviated in the molding process, so as to enhance the luminous flux, the uniformity of the color temperature and the color saturation of each LED of the same color series.

Another objective of the present invention is to form a light guide line along the external periphery of the molded casing, such that the light can be spread towards a direction of a predetermined angle.

### BRIEF DESCRIPTION OF THE DRAWINGS

FIG, 1 is a perspective view of an LED casing structure of the present invention;

FIG. 2 is a cross-sectional view of an LED casing structure of the present invention;

FIG. 3 is a cross-sectional view of an LED casing structure of another shape in accordance with the present invention;

FIG. 4 is a schematic view of an LED casing structure with a light guiding angle at an external periphery of the LED casing structure in accordance with the present invention;

FIG. 5 is a cross-sectional view of another LED casing structure in accordance with the present invention;

FIG. 6 is a perspective view of a conventional LED structure; and

FIG. 7 is a cross-sectional view of a conventional LED structure,

### DETAILED DESCRIPTION OF THE PREFERRED EMBODIMENTS

The technical characteristics of the present invention will become apparent with the detailed description of the preferred embodiments and the illustration of the related drawings,

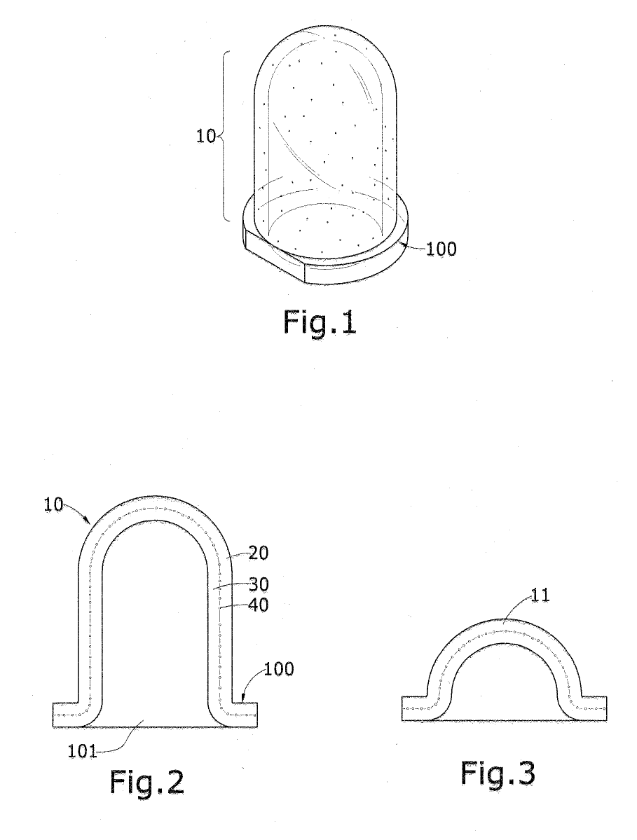

With reference to FIGS. 1 and 2 for a casing having a cylindrical cup 10 in accordance with the present invention, an accommodating portion 101 is formed inside the casing, and a protrusion 100 is extended outwardly from an end of the cup 10 and abutted easily, and the cup 10, the protrusion 100 and at least two plastic film layers 20, 30 are stacked, and a uniformly distributed phosphor 40 is included between the two plastic film layers 20, 30.

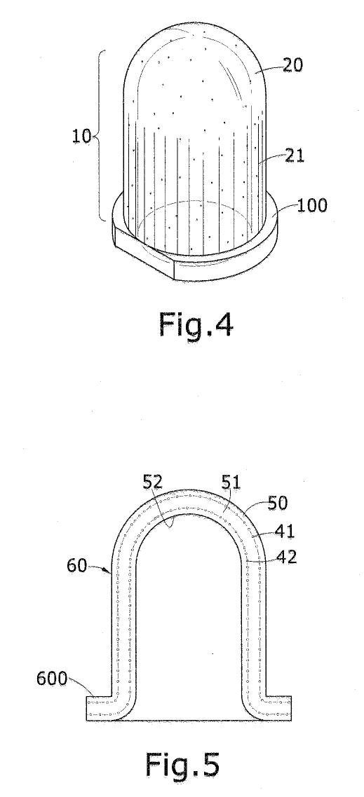

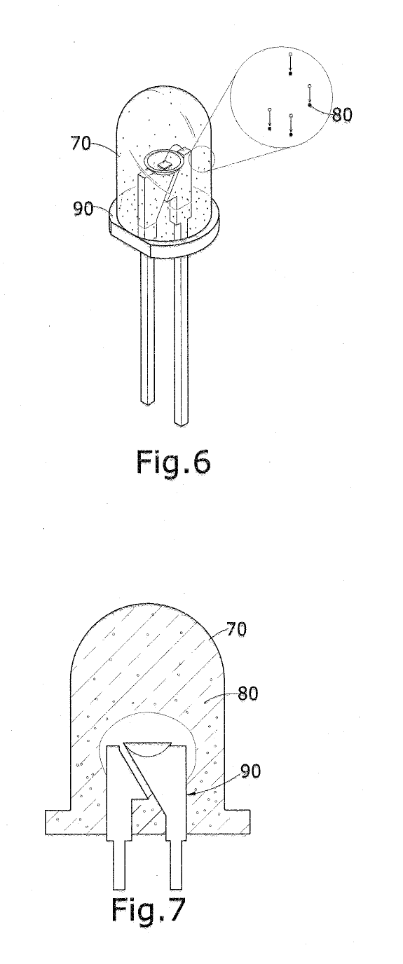

With reference to FIG. 4, an embossing line 21 is formed around the bottom of the periphery of the cup 10 for guiding light, such that the light can be guided, reflected or refracted by the light guiding embossing line 21 and projected towards the front in a specific angle such as 60 degrees, 90 degrees, 120 degrees or any specific angle. However, the aforementioned arrangement is in prior art, and thus will not be described here again.

With reference to FIG. 2 for a cylindrical cup 10 and FIG. 3 for a semicircular or an arch-shaped cup 11 having a greater curvature, two different shapes of the cup constitute two preferred embodiments of the present invention respectively.

With reference to FIG. 5 for another LED casing structure in accordance with the present invention, the cup 60 and the protrusion 600 are formed by stacking three or more plastic film layers 50, 51, 52, and at least two layers of phosphor 41, 42 are uniformly distributed and included among the three plastic film layers 50, 51, 52, and the two layers of phosphor 41, 42 are made of the same chemical composition or different chemical compositions to achieve the uniform color effect. Similarly, a multilayer casing structure having more than three layers can be adopted in the present invention.

In the casing structure of the invention, the phosphor is included in the multilayer structure, so that the phosphor will be unable to move, and the LED will have a uniform quality. Since the uniformity of the phosphor can be controlled easily and the phosphor cannot be moved, therefore the luminous flux of the LED and the uniform color temperature and color saturation of each LED of the same color series can be enhanced.

With the structural design of the present invention, two different phosphors can be used for activating the light more uniformly, so as to provide a wider scope of applicability.

The present invention improves over the prior art and complies with patent application requirements, and thus is duly filed for the patent application. While the invention has been described by device of specific embodiments, numerous modifications and variations could be made thereto by those generally skilled in the art without departing from the scope and spirit of the invention set forth in the claims.

What is claimed is:

1. A light emitting diode casing structure, comprising:
a hollow cup, having an accommodating portion formed therein, and being formed by stacking at least two plastic film layers; and
a phosphor, distributed between the two plastic film layers uniformly.

2. The light emitting diode casing structure of claim 1, wherein the cup comprises a protrusion extended outwardly from an end of the cup and abutted easily against an external side of the cup.

3. The light emitting diode casing structure of claim 1, wherein the cup comprises an embossing line disposed around an external periphery of the cup for guiding light.

4. The light emitting diode casing structure of claim 1, wherein the cup is a cylindrical cup,

5. The light emitting diode easing structure of claim 1, wherein the cup is in a semicircular shape.

6. A light emitting diode casing structure, comprising:
a hollow cup, having an accommodating portion formed therein, and being formed by stacking at least three plastic films;
at least two layers of phosphor, distributed among the three plastic film layers uniformely.

7. The light emitting diode casing structure of claim 6, wherein the two layers of uniformly distributed phosphor have the same chemical composition.

8. The light emitting diode easing structure of claim 6, wherein the two layers of uniformly distributed phosphor have different chemical compositions.

9. A light emitting diode casing structure, comprising:
a hollow cup, having an accommodating portion formed therein, and being formed by stacking three plastic film layers; and
at least one layer of phosphor, distributed among the three plastic film layers uniformly.
